(19) United States
(12) Patent Application Publication
(10) Pub. No.: US 2014/0157248 A1
(43) Pub. Date: Jun. 5, 2014

(54) CONVERSION APPARATUS, METHOD OF CONVERTING, AND NON-TRANSIENT COMPUTER-READABLE RECORDING MEDIUM HAVING CONVERSION PROGRAM STORED THEREON

(71) Applicant: Fujitsu Limited, Kawasaki-shi (JP)

(72) Inventor: Shigeru KIMURA, Hachioji (JP)

(73) Assignee: Fujitsu Limited, Kawasaki-shi (JP)

(21) Appl. No.: 14/065,530

(22) Filed: Oct. 29, 2013

(30) Foreign Application Priority Data
Dec. 5, 2012 (JP) 2012-266723

(51) Int. Cl. G06F 9/45

(52) U.S. Cl. CPC G06F 8/443
USPC 717/151

(57) ABSTRACT

A conversion apparatus for converting a source code into a machine language code, includes an information obtainment unit that obtains profile information from the source code; a determination unit that determines an optimal position of a prefetch command for access to a multi-dimensional array of multiple loops having a nest level of two or greater, on the basis of the profile information; and a placement unit that places the prefetch command at the optimal position.

### CROSS-REFERENCE TO RELATED APPLICATIONS

This application is based upon and claims the benefit of priority of the prior Japanese Patent Application No. 2012-266723, filed on Dec. 5, 2012, the entire contents of which are incorporated herein by reference.

### FIELD

The embodiments discussed herein are directed to a conversion apparatus, a method of converting, and a non-transient computer-readable recording medium having a conversion program stored thereon.

### BACKGROUND

In general, an information processing apparatus includes a cache memory enabling higher-speed data access than a main memory in a central processing unit (CPU). The cache memory accommodates recently referenced data to reduce the latency caused by main memory reference.

Frequent cache failures are however caused by low locality of referenced data in calculation using large-scale data such as a numerical calculation process, data base access, and multimedia data such as an image and audio through a network (for example, the Internet). As a result, the latency caused by main memory reference cannot sufficiently be reduced.

In order to prevent such cache failure for large-scale data, for example, a prefetch command for moving data from the main memory to the cache memory before actual use of data is prepared in a CPU. Additionally, a technique of placing the prefetch command in a program by a compiler is proposed.

Various techniques such as loop division are proposed in order to speed up such a prefetch in a loop process. Even if such a technique is employed, loops increasing due to loop division lead to an increase in branch determination processes, or an increase in loop procedures leads to an increase in the number of times of command cache failure. This may degrade the performance.

### SUMMARY

In accordance with the present invention, a conversion apparatus for converting a source code into a machine language code includes: an information obtainment unit that obtains profile information from the source code; a determination unit that determines an optimal position of a prefetch command for access to a multi-dimensional array of multiple loops having a nest level of two or greater, on the basis of the profile information; and a placement unit that places the prefetch command at the optimal position.

In accordance with the present invention, a method of converting a source code into a machine language code includes: obtaining profile information from the source code; determining an optimal position of a prefetch command for access to a multi-dimensional array of multiple loops having a nest level of two or greater, on the basis of the profile information; and placing the prefetch command at the optimal position.

In accordance with the present invention, a non-transient computer-readable recording medium having a conversion program stored thereon, for converting a source code into a machine language code is executed by a computer and causes the computer to obtain profile information from the source code; determine an optimal position of a prefetch command for access to a multi-dimensional array of multiple loops having a nest level of two or greater, on the basis of the profile information; and place the prefetch command at the optimal position.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates a hardware configuration of an information processing apparatus according to a first embodiment;

FIG. 2 illustrates a configuration of a development system performed in the information processing apparatus according to the first embodiment;

FIG. 3 illustrates a configuration of the compiler according to the first embodiment;

FIG. 4 illustrates the operation of a prefetch command placement unit according to the first embodiment;

FIG. 5A illustrates an original loop in an example operation of the prefetch command placement unit according to the first embodiment;

FIGS. 5B and 5C illustrate a loop after applying prefetch in an example operation of the prefetch command placement unit according to the first embodiment;

FIG. 6 illustrates an operation of an innermost access scheme for a placement unit according to the first embodiment;

FIG. 7 illustrates an operation of a high-order access scheme for the placement unit according to the first embodiment;

FIG. 8 is a flow chart illustrating an acquisition process on profile information by a compiler according to the first embodiment;

FIG. 9 is a flow chart illustrating a process of placing a prefetch command by the compiler according to the first embodiment;

FIG. 10 is a flow chart illustrating the process of placing a prefetch command by a prefetch command placement unit according to the first embodiment;

FIG. 11 illustrates an example program;

FIG. 12 illustrates a memory access operation through the innermost access scheme in x<y;

FIG. 13 illustrates a memory access operation through the high-order access scheme in x<y;

FIG. 14 illustrates a memory access operation through the innermost access scheme in x>y;

FIG. 15 illustrates a memory access operation through the high-order access scheme in x>y;

FIG. 16 illustrates the summarized results of FIGS. 12 to 15;

FIG. 17 illustrates the operation of a prefetch command placement unit according to a second embodiment;

FIG. 18 is a flow chart illustrating a process of placing a prefetch command according to the second embodiment;

FIG. 19 illustrates the operation of a prefetch command placement unit according to a modification to the second embodiment; and

FIG. 20 is a flow chart illustrating a process of placing a prefetch command according to the modification to the second embodiment.

### DESCRIPTION OF EMBODIMENTS

Hereinafter, exemplary embodiments will be described with reference to the accompanying drawings.

### (A) FIRST EMBODIMENT

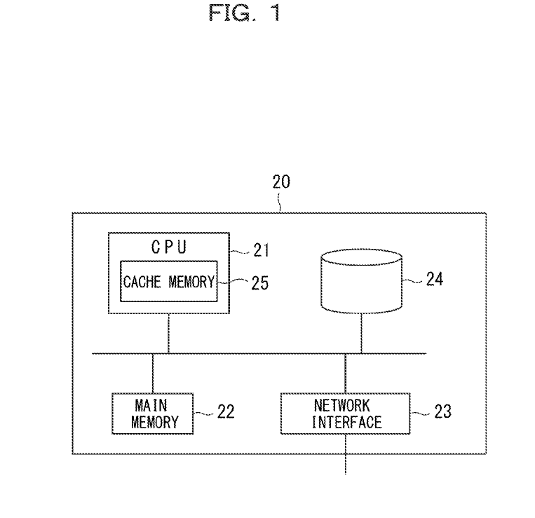

FIG. 1 illustrates a hardware configuration of an information processing apparatus 20 according to a first embodiment.

The information processing apparatus 20 includes a CPU (processor) 21, a main memory 22, a network interface 23, and a storage 24.

The CPU 21 is a processor performing various controls and calculations, reads, for example, programs and an operating system (OS) that are stored in the storage 24 described below, and performs various processes. The CPU 21 can be implemented, for example using a known CPU.

The main memory 22 is a storage such as a random access memory (RAM), and stores programs performed by the CPU 21, various types of data, and data obtained by operations of the CPU 21, for example.

The CPU 21 includes a cache memory 25 that is a storage enabling higher-speed data access than the main memory 22, in order to reduce latency caused by main memory reference to the main memory 22. The CPU 21 reduces the latency by, for example, placing data recently referred to by the CPU 21, in the cache memory 25. The cache memory 25 can be implemented, for example, using a known static RAM (SRAM).

The network interface 23 is a communication adapter such as a local area network (LAN) card, and connects the information processing apparatus 20 to an external network (not illustrated) such as a LAN.

The storage 24 stores and saves various programs, an OS, and data, and operates as a built-in disk of the information processing apparatus 20. The storage 24 is, for example, a hard disk drive (HDD).

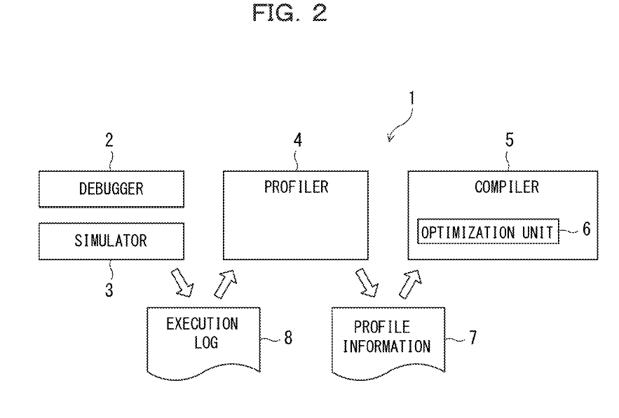

FIG. 2 illustrates a configuration of a development system 1 for developing a machine language program (machine language code) performed in the information processing apparatus 20 according to the first embodiment.

The development system 1 develops a machine language program to be performed in the CPU 21 of the information processing apparatus 20. The development system 1 includes a debugger 2, a simulator 3, a profiler 4, and a compiler (converter) 5.

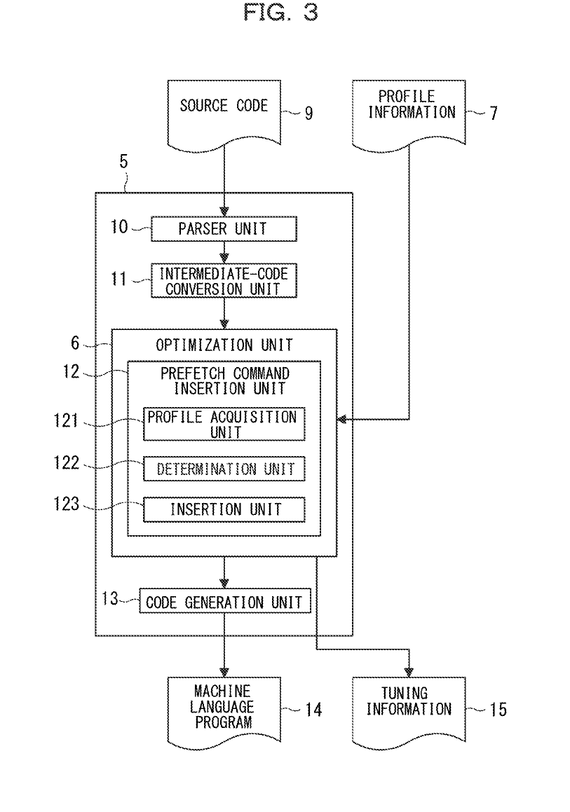

The compiler 5 is a program reading a source code 9 (refer to FIG. 3) described in a high-level language such as FORTRAN or C language and profile information 7 outputted from the profiler 4 described below, and 2 0 converting the source code 9 and the profile information 7 into a machine language program 14 (refer to FIG. 3). A configuration of the compiler 5 will be described below with reference to FIG. 3.

The debugger 2 is a program for specifying the position and the cause of a bug found during compiling of the source code 9 (refer to FIG. 3) in the compiler 5.

The simulator 3 is a program virtually performing the machine language program 14 (refer to FIG. 3). The execution result of the simulator 3 is outputted as an execution log 8.

The profiler 4 is a program analyzing the execution log 8 and outputting the profile information 7 used as hint information such as optimization in the compiler 5.

The profile information 7 holds, for example, a variable for the number of times of loop execution and the number of times of the satisfaction of a condition in a branch determination during execution. For example, the profile information 7 contains information on the rotation number performed in each loop level. The compiler 5 unwinds the optimal object code (machine language code) with reference to the profile information 7 during this execution.

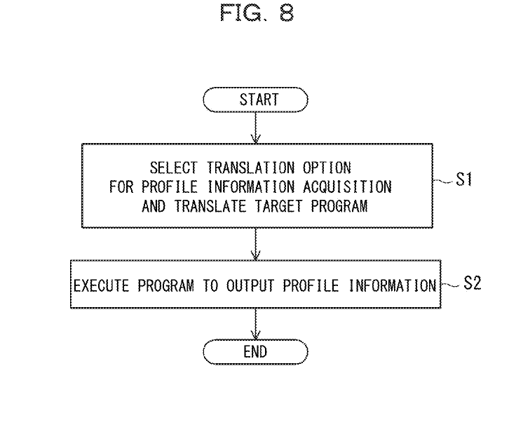

In addition, a process of acquiring the profile information 7 will be explained below with reference to FIG. 8.

FIG. 3 illustrates a configuration of the compiler 5 according to the first embodiment.

As explained above, the compiler 5 is a program converting the source code 9 into the machine language program 14 treating the CPU 21 (refer to FIG. 1) as a target processor. The compiler 5 is performed on the information processing apparatus such as the information processing apparatus 20 and includes, for example, a parser unit 10, an intermediate-code conversion unit 11, an optimization unit 6, and a code generation unit 13.

The parser unit 10 is a preprocessing unit extracting, for example, reserved words (keywords) from the source code 9 to be compiled and lexically analyzes the source code.

The intermediate-code conversion unit 11 is a process unit converting each statement of the source code 9 sent from the parser unit 10 into an intermediate code, on the basis of a predetermined rule. In general, this intermediate code refers to a code expressed in the form of a function call. The intermediate code also includes a machine language command for the CPU 21 in addition to such a code in a function-call form. When the intermediate-code conversion unit 11 generates an intermediate code, it generates the optimal intermediate code with reference to the profile information 7.

The optimization unit 6 processes, for example, command combination, redundant removal, and command rearrangement, and register allocation on an intermediate code outputted from the intermediate-code conversion unit 11, thereby enhancing the execution speed and reducing the code size, for example. The optimization unit 6 includes a prefetch command placement unit 12 performing optimization specialized for the compiler 5 in addition to a usual optimization process.

The prefetch command placement unit 12 includes a profile acquisition unit (information obtainment unit) 121, a determination unit 122, and a placement unit 123.

The profile acquisition unit 121 acquires various types of information on a target program from the profile information 7. For example, the profile acquisition unit 121 acquires, for example, information on the loop structure of a target program and on whether array access is strided. For example, the profile acquisition unit 121 acquires the number y of execution times (rotation number) in the innermost loop, and the number x of execution times (rotation number) in the second innermost loop (hereinafter referred to as “outer loop” or “outside loop”) in the loops nested in the program.

The determination unit 122 compares the information acquired by the profile acquisition unit 121. In an example case of strided accessing to a multi-dimensional array in a multiloop structure, the determination unit 122 compares the number x of execution times in the outer loop with the number y of execution times in an innermost loop.

The placement unit 123 automatically determines a position for placing a prefetch command on the basis of the result of the comparison obtained by the determination unit 122, and places the prefetch command.

Operations of the profile acquisition unit 121, the determination unit 122, and the placement unit 123 will be explained below.

In addition to the above, the optimization unit 6 also outputs tuning information 15 used as hints for a user re-creating the source code 9, the tuning information 15 being concerned with, for example, cache failure in the cache memory 25.

The code generation unit 13 generates the machine language program 14 by replacing all of the intermediate codes outputted from the optimization unit 6, with machine language commands with reference to, for example, a conversion table (not illustrated) held in the code generation unit 13.

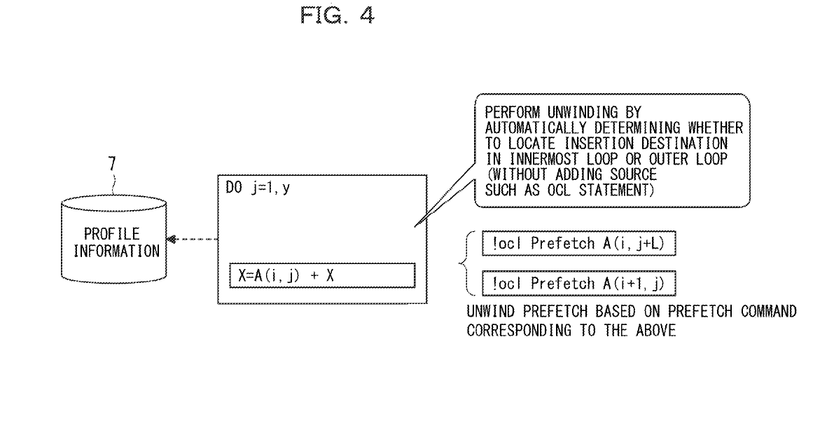

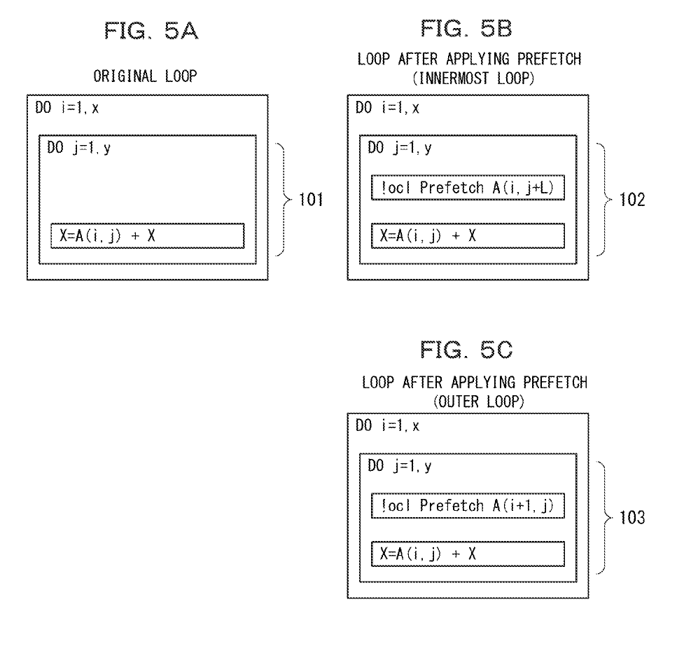

Hereinafter, an operation of the prefetch command placement unit 12 in the optimization unit 6 will be explained with reference to FIGS. 4 and 5.

FIG. 4 illustrates the operation of the prefetch command placement unit 12 according to the first embodiment. FIGS. 5A to 5C illustrate an original loop in an example operation of the prefetch command placement unit 12 according to the first embodiment. FIGS. 5B and 5C illustrate a loop after applying prefetch in an example operation of the prefetch command placement unit 12 according to the first embodiment.

As illustrated in FIG. 4, the profile acquisition unit 121 reads the profile information 7. In the case of strided accessing to a multi-dimensional array in a multiloop structure, the determination unit 122 then determines whether the number x of execution times in the outer loop is smaller than the number y of execution times in an innermost loop. In a processor including a hardware prefetch mechanism continuation in sequential accessing, hardware performs automatic prefetch. This may degrade the performance due to prefetch performed by execution of a software command according to the present embodiment. Additionally, when an access region can be judged to be continuous, optimization in the compiler 5 may internally reduce the array dimension number. An example of the present embodiment is effective in discontinuous access unaffected in the above situation, i.e., strided access. Consequently, strided access to an array will be explained below.

The example of the present embodiment is not limited to strided access at intervals but is similarly applicable to access to even a sequential region.

When the number x of execution times in the outer loop equal to or more than the number y of execution times in the innermost loop, the placement unit 123 places a prefetch command in the innermost loop. That is, the placement unit 123 outputs an object code (machine language code) unwinding a prefetch command for data access in the direction of the number of execution times (this is hereafter referred to as “innermost access scheme” or “horizontal prefetch scheme”). Consequently, an object code unwinding a prefetch command is generated at a position as illustrated in FIG. 5B.

For convenience of explanation in FIGS. 4 and 5A to 5C, an ocl statement is described in the code. The ocl statement is however not added to the machine language code in reality by the placement unit 123. The machine language code unwinding the prefetch command equivalent to the ocl statement is outputted in reality.

If the number x of execution times in the outer loop is smaller than the number y of execution times in the innermost loop, the placement unit 123 places a prefetch command in the outer loop. That is, the placement unit 123 outputs an object code unwinding a machine language performing prefetch on data in the next outer loop (this is hereinafter referred to as “high-order access scheme” or “vertical prefetch scheme”). Consequently, an object code unwinding a prefetch command is generated at a position as illustrated in FIG. 5C.

In this way, the prefetch command placement unit 12 according to the first embodiment acquires a loop count from the profile information 7 and automatically unwinds a prefetch command in the optimal position, thereby shortening the latency from the main memory 22.

A two-dimensional array will be explained below, but the example of the present embodiment is not limited to a two-dimensional array and is also applicable to a three- or more-dimensional array.

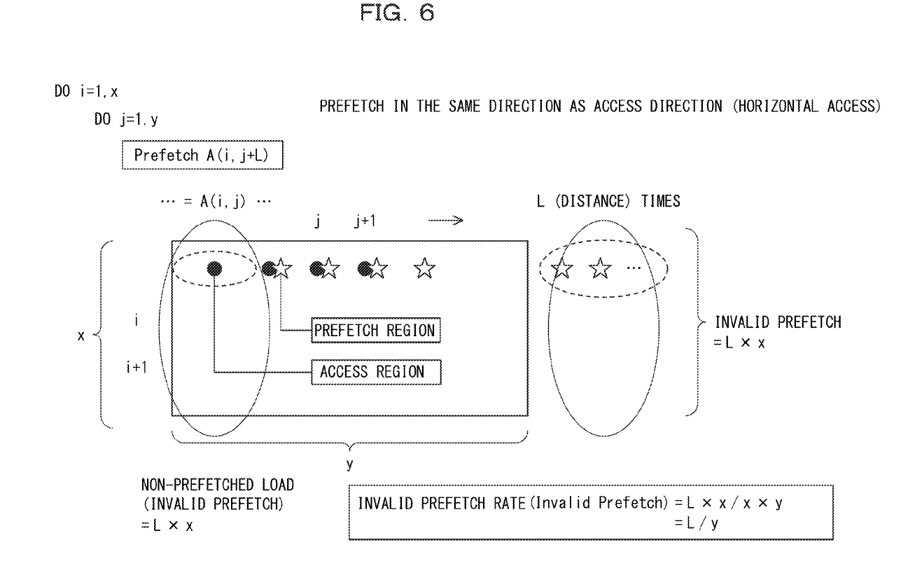

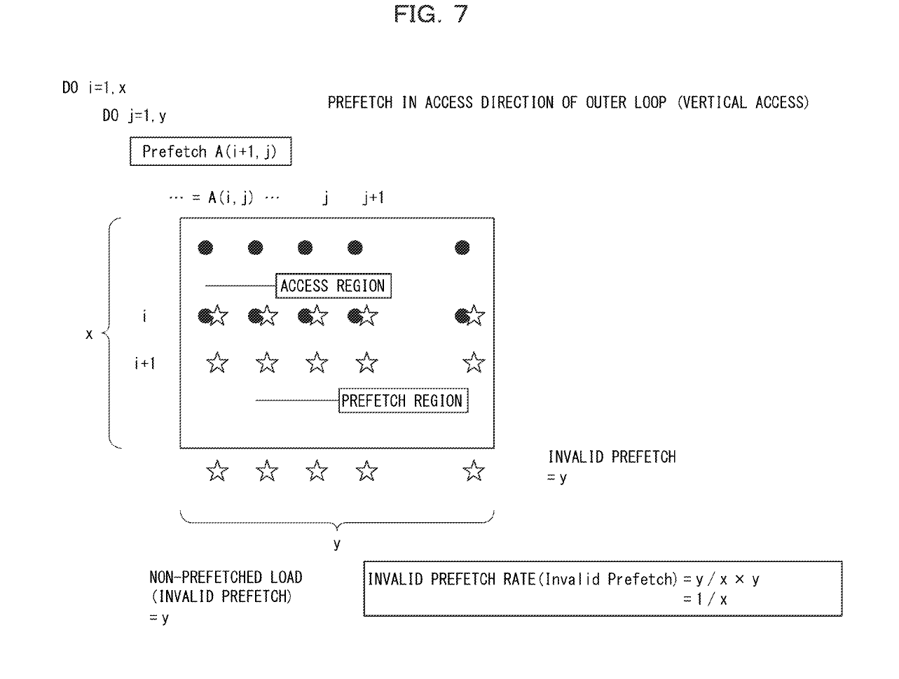

Hereinafter, this point will be explained with reference to FIGS. 6 and 7.

FIG. 6 illustrates an operation of the innermost access scheme for the placement unit 123 according to the first embodiment. FIG. 7 illustrates an operation of the high-order access scheme for the placement unit 123 according to the first embodiment.

In the examples illustrated in FIGS. 6 and 7, the program accesses a two-dimensional array A having an array size (x, y). In the drawing, L is a distance to an array element subject to prefetch, i.e., a value indicating which subsequent data of the array element is subject to prefetch. Black circles indicate array elements actually accessed while asterisks indicate array elements subject to prefetch.

In the innermost access scheme as illustrated in FIG. 6, the program performs prefetch on an array element located after L elements in the access direction (the forward direction of the innermost loop variable j, i.e., the direction of j, or the right direction in FIGS. 6 and 7).

In FIG. 6, if each array element of the two-dimensional array A has an element size of I, the relative position of the array element having additional characters (i, j) from the head region of the array can be represented in general by the following expression:

{(i−1)+(j−1)×x}×I Expression (1)

At this time, the offset L between elements of data to be subject to prefetch is calculated in a loop 101 as illustrated in FIG. 5A, based on the number of cycles taken for prefetch from the main memory 22 to the cache memory 25 and the number of predicted execution cycles in the loop.

Next, a prefetch command “Prefetch” is placed such that the prefetch on data is performed in a loop located the offset L after from the loop using the data, as illustrated in the loop 102 of FIG. 5B.

As a result, the memory relative address of the prefetch target A(i, j+L) from the head of the array in the same j access direction as the loop through the innermost access scheme is represented by the following expression:

{(i−1)+(j+L−1)×x}×I Expression (2)

At this time, a stride width in FIG. 6 is equal to L×x×I.

In this example, the number of times of loading subject to no prefetch (non-prefetch load), i.e., invalid prefetch is equal to L×x.

Since the total number of times of access is x×y, the rate of the number of times of an invalid prefetch to all the number of times of access, i.e., an invalid prefetch rate (non-prefetch load rate) is represented by the following expression:

L×x/(x×y)=L/y Expression (3)

However, when y is smaller than x (x>y) in Expression (3), the invalid prefetch rate increases to decrease the prefetch efficiency.

Consequently, when y is smaller than x (x>y), the prefetch command placement unit 12 performs the high-order access scheme as illustrated in FIG. 7, i.e., performs prefetch on the next element A(i+1, j) that is located the stride width x×I after in the direction (in this example, the access direction of the outer loop, i.e., the direction of i) different from the access direction (direction of j).

The number of times of the invalid prefetch (non-prefetch load) at this time is equal to y.

As a result, the invalid prefetch rate (non-prefetch load rate) is represented by the following expression:

y/(x×y)=1/x Expression (4)

As a result, when x>y, i.e., when the number x of execution times of the outer loop is smaller than the number y of execution times of the innermost loop, the prefetch command placement unit 12 according to the present embodiment places a prefetch command for performing prefetch in the direction (i) different from the access direction (j). Thereby, the invalid prefetch rate in x>y is smaller than that in the innermost access scheme to enhance the prefetch efficiency. This is because 1/x<1/L/y is satisfied. The high-order access scheme employs the access element A (i+1, j). One-dimensional access target is however not limited to i+1 but may be modified to have a one-dimensional element i+n, such as A(i+2, j), depending on the relationship between the memory latency for the element A(i+1, j) and the number of cycles taken for calculation for the reference.

Hereinafter, an acquisition process on the profile information 7 by the compiler 5 will be explained with reference to FIG. 8.

FIG. 8 is a flow chart illustrating the acquisition process on the profile information 7 by the compiler 5 according to the first embodiment.

In Step S1, the compiler 5 selects a translation option for profile information acquisition, and translates a target program.

In Step S2, the compiler 5 next executes the program to output the profile information 7. The profile information 7 contains, for example, a loop count and a loop attribute for each loop.

A process of placing a prefetch command will now be explained.

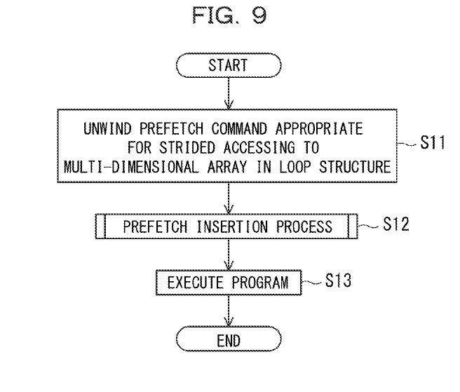

FIG. 9 is a flow chart illustrating a prefetch command process by the compiler 5 according to the first embodiment.

In Step S11, the compiler 5 reads the source code 9 and unwinds a prefetch command appropriate for strided accessing to a multi-dimensional array in a multiloop structure.

In Step S12, the prefetch command placement unit 12 next performs the prefetch command process described below.

In Step S13, a user next executes the program.

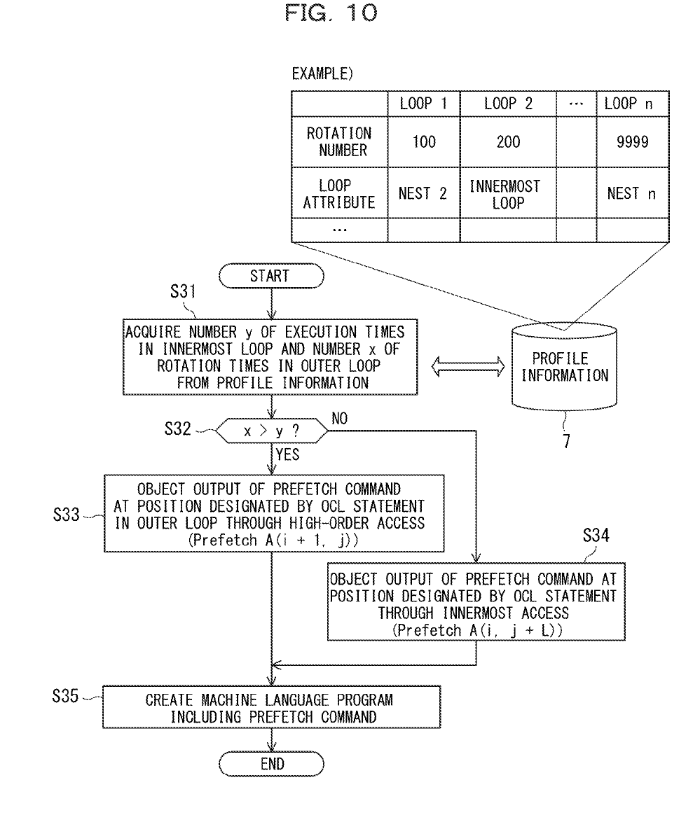

The process of placing a prefetch command performed by the prefetch command placement unit 12 in Step S12 of FIG. 9 will now be explained with reference to FIG. 10.

FIG. 10 is a flow chart illustrating the process of placing a prefetch command by the prefetch command placement unit 12 according to the first embodiment.

In Step S31, the profile acquisition unit 121 acquires the number y of execution times in the innermost loop, and the number x of execution times in the outer loop with reference to the profile information 7.

In Step S32, the determination unit 122 then determines whether the number y of execution times in the innermost loop acquired by the profile acquisition unit 121 in Step S31 is smaller than the number x of execution times in the outer loop.

When y is smaller than x in Step S32 (refer to YES in Step S32), the placement unit 123 places a prefetch command into the outer loop through the high-order access scheme in Step S33. For example, the prefetch command placement unit 12 places an object corresponding to Prefetch A (i+1, j) based on OCL designation into the outer loop. In the machine language program 14, the compiler 5 finally unwinds the OCL designation by the user and a machine language command equivalent to Prefetch A (i+1, j).

The “OCL designation” is an instruction to the compiler that can be designated (allocated) in a FORTRAN source code by the user as appropriate. The “OCL designation” is a character string starting with !ocl, which is equivalent to a syntax including a character string starting with “#pragma” in the language C.

Even if the user does not clearly designate “OCL designation” in the source, the compiler can automatically output a machine language command equivalent to the “OCL designation” in response to a designation of a parameter option (such as—prefech) given during the translation. This example uses FORTRAN, but any other programming languages such as C language can be used alternatively.

If y is equal to or more than x in Step S32 (refer to NO in Step S32), the placement unit 123 places the prefetch command in the innermost loop at the position designated by the ocl through the innermost access scheme in Step S34. For example, the prefetch command placement unit 12 places an object corresponding to Prefetch A(i, j+L) (L is the distance of prefetch) in the outer loop.

In Step S35, the compiler 5 next creates the machine language program 14 including the prefetch command.

Hereinafter, an operation of the prefetch command placement unit 12 will be explained with reference to a specific example.

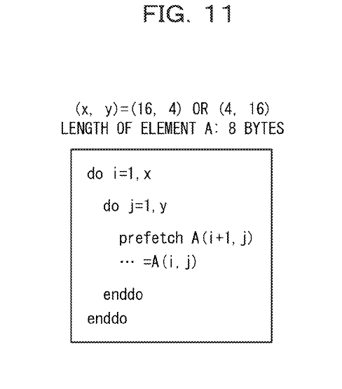

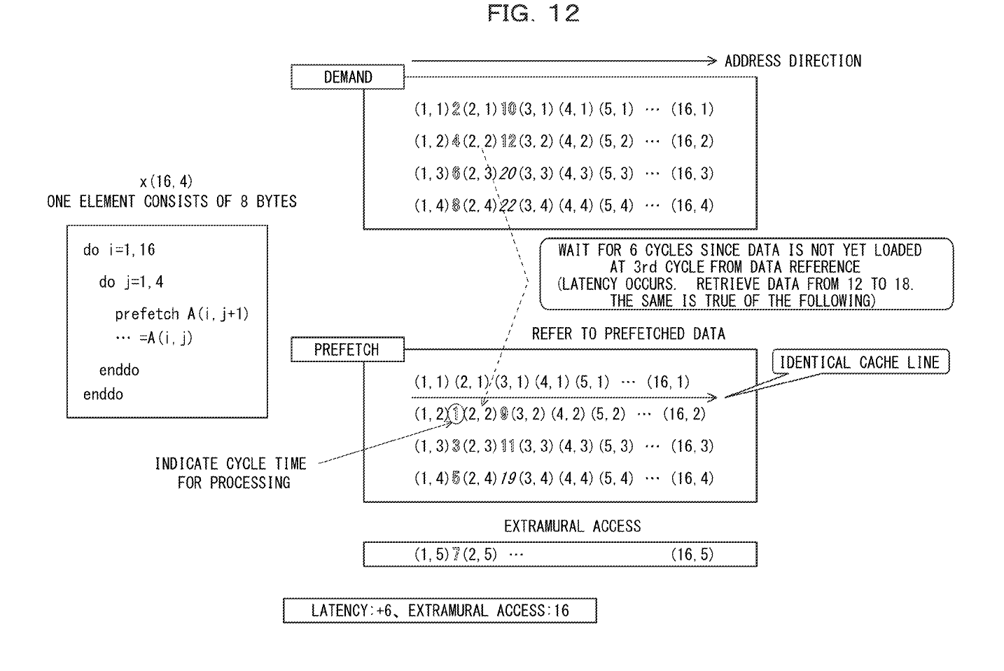

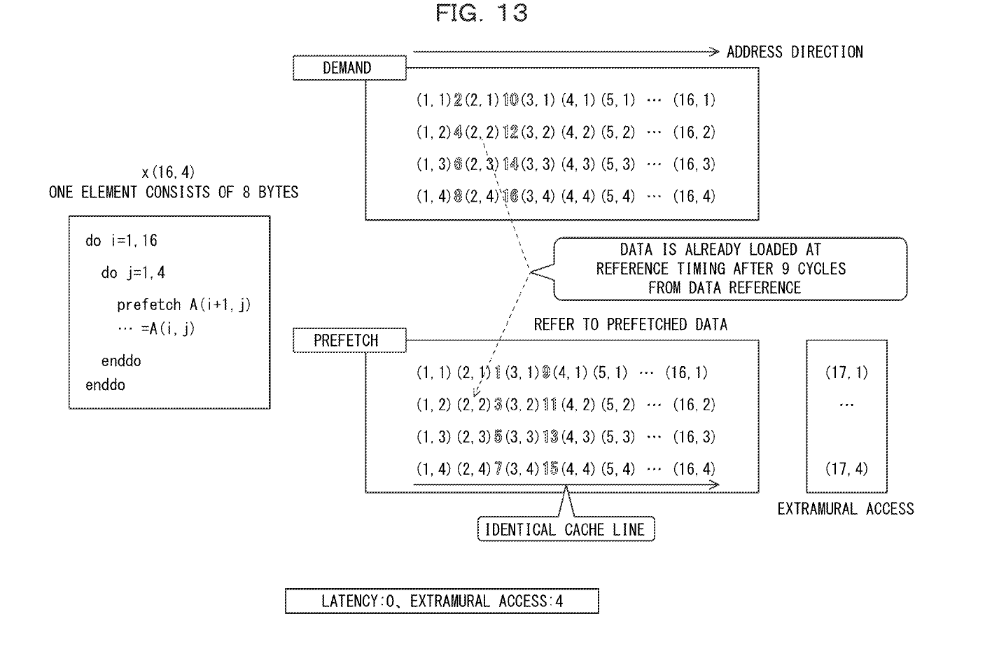

FIGS. 12 and 13 illustrate memory access operations to the multi-dimensional array A through the innermost access scheme and the high-order access scheme, respectively, during the execution of the program in x>y illustrated in FIG. 11. In the example illustrated in FIGS. 12 and 13, since x=16 and y=4, x>y is satisfied.

In this example, it is assumed that, for example, each process takes the following number of cycles (time).

Time taken for retrieving data from the main memory 22 to the cache memory 25 is assumed to be equal to nine cycles in the case of a cache failure.

Read time for data from the cache memory 25 during cache hit is assumed to be one cycle.

Additionally, processing time for each prefetch and demand (i.e., load A(i, j)) is assumed to be one cycle.

In this example, process cycles other than the above are disregarded.

As illustrated in FIG. 11, the element of the multi-dimensional array A has a length of eight bytes.

In FIGS. 12 and 13, expressions such as (1, 1) indicate array data. An outline number and an italic number to the right of an array indicate cycle time for processing; in specific, they indicate the number of cycles excluding the latency for prefetch data and the number of cycles including the latency for prefetch data, respectively.

In the drawings, the cycle time is illustrated only in some array data for convenience.

The innermost access scheme of FIG. 12 accesses data A(2, 2) through prefetch in the ninth cycle (refer to the number “9” to the right of (2, 2) in “PREFETCH”); whereas demand access to A(2, 2) in the program is performed in the 12th cycle, which is three cycles later than the prefetch (refer to the number “12” to the right of (2, 2) in “DEMAND”). As described above, nine cycles are taken for retrieving data from the main memory 22 to the cache memory 25 in the case of cache failure. As a result, waiting time of six cycles occurs, and then data can be eventually referenced in 18th cycle. Assuming that cache failure occurs at the timing of access to (2, 2), demand access to (2, 3) is performed in six cycles later than the cache failure, i.e., in the 20th cycle.

In the same manner, the number of cycles of the waiting time caused by the cache failure is then added at the head of a cache memory line (since the cache memory 25 is hit in data access in the same cache memory line, data can be read from the cache memory 25 in one cycle). Furthermore, useless prefetch outside the region occurs 16 times.

In contrast to this, the high-order access scheme of FIG. 13 accesses data A(2, 2) through prefetch in the third cycle (refer to the number “3” to the right of (2, 2) in “PREFETCH”); whereas demand access to A(2, 2) in the program is performed in nine cycles after the prefetch, i.e., in the 12th cycle (refer to the number “12” to the right of (2, 2) in “DEMAND”).At this timing, data involving cache failure is already retrieved from the main memory 22 to the cache memory 25 to be stored therein. This enables access to data in the cache memory 25, which involves no latency.

Likewise, due to the cache failure in access to the head of the cache memory line, retrieving data from the main memory 22 to the cache memory 25 takes nine cycles, but involves no latency. Useless prefetch (hereinafter referred to as extramural access) on unnecessary data can be reduced to four times.

In this way, the effect of prefetch varies depending on the magnitude relationship between the number y of execution times in the innermost loop and the number x of execution in the outer loop.

That is, the high-order access scheme is effective when the number y of execution times in the innermost loop is smaller than the number x of execution times in the outer loop. On the other hand, the innermost access scheme is effective when y is equal to or more than x.

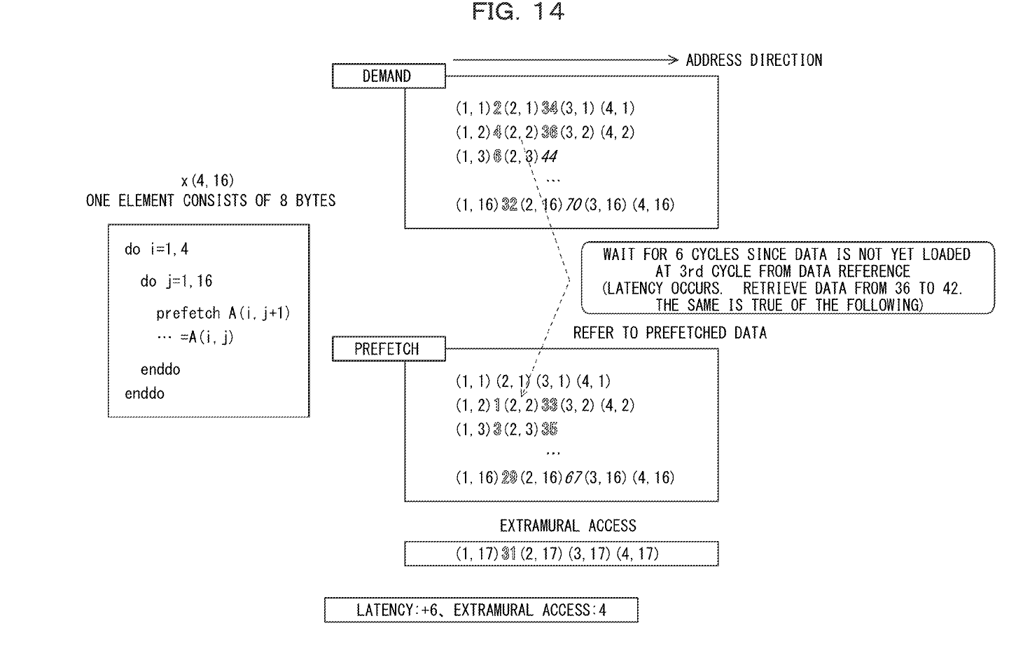

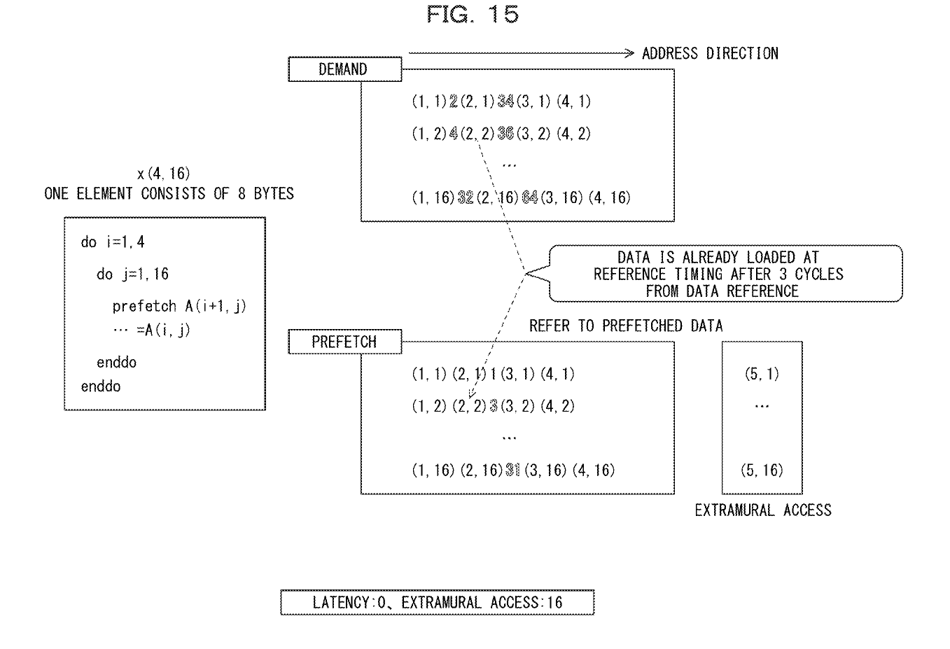

For comparison, FIGS. 14 and 15 illustrate memory access operations through the innermost access scheme and the high-order access scheme, respectively, during the execution of the program in x<y illustrated in FIG. 11. In the example illustrated in FIGS. 14 and 15, since x=4 and y=16, x<y is satisfied.

The number of process cycles in each process in this example is also assumed to be equal to the above-described value.

In the examples as illustrated in FIGS. 14 and 15, when the number y of execution times in the innermost loop is larger than the number x of execution times in the outer loop, the innermost access scheme involves latency for six cycles and four times of extramural access. In contrast to this, the high-order access scheme involves no latency but causes extramural access no less than 16 times. As a result, the innermost access scheme is more effective.

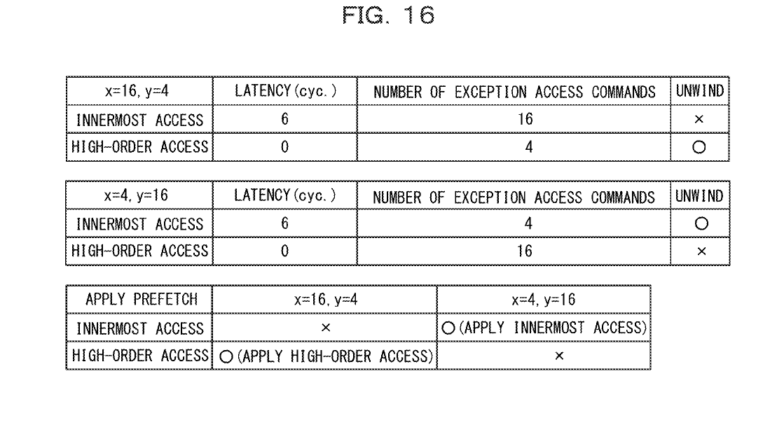

The results in FIGS. 12 to 15 are summarized in FIG. 16.

As illustrated in FIG. 16, the prefetch command placement unit 12 places a prefetch command through the high-order access scheme in x=16 and y=4. This case causes no latency and four extramural access commands, which are less than those caused in the innermost access scheme.

On the other hand, the prefetch command placement unit 12 places a prefetch command through the innermost access scheme in x=4 and y=16. As described above, this case causes latency for six cycles and sixteen extramural access commands; the latency increases, but the number of extramural access commands is significantly reduced in comparison with those caused in the high-order access scheme. This results in high performance. In this case (x<y), the innermost access scheme is more advantageous than the high-order access scheme. Alternatively, the compiler 5 can judge the trade-off between the latency and the number of exception access commands on the basis of the profile information 7 depending on the process contents of the program, and performs unwinding through an optimal scheme (the innermost access scheme or the high-order access scheme) in the case of x<y.

In this way, prefetch can be effectively applied even to multiple loops including an innermost loop having a short length and an outside loop having a long length through the high-order access scheme, according to the first embodiment.

In the first embodiment, the order of additional characters for accessing the elements of a two- or more-dimensional array is determined on the basis of the size of the array through the high-order access scheme and the innermost access scheme.

In the high-order access scheme, a prefetch target is switched for multiple loops including an innermost loop having a short length and an outside loop having a long length. This can prevent the side effect of prefetch, i.e., the performance degradation due to an increase in the invalid prefetch rate (non-prefetch load).

Additionally, the compiler 5 can automatically select an optimal prefetch output (the innermost access scheme or the high-order access scheme) based on the profile information 7. This technique is applicable to a multiple loops including an innermost loop having a short length and an outside loop having a long length through the high-order access scheme. This technique can be applicable to any other case. The compiler 5 can determine the trade-off between the latency and the number of exception access commands on the basis of the profile information 7, and can automatically select an optimal prefetch output (the innermost access scheme or the high-order access scheme) even in the case of the innermost loop having a length longer than that of the outside loop.

Furthermore, such an automatic selection of a prefetch scheme can provide efficient prefetch and a reduction in man-hours for the user operation.

### (B) SECOND EMBODIMENT

In the first embodiment, the prefetch command placement unit 12 determines the use of a prefetch command in a program on the basis of the profile information 7, and automatically selects the innermost access scheme or the high-order access scheme to determine the placement position of the prefetch command. The present invention is however not limited to this technique. Alternatively, a user may select whether to use a prefetch command.

In the second embodiment, the user uses, for example, OCL syntax to clearly designate the use of a prefetch command. The prefetch command placement unit 12 automatically selects the innermost access scheme or the high-order access scheme for the determination of the placement place of a prefetch command on the basis of the profile information 7 during compiling.

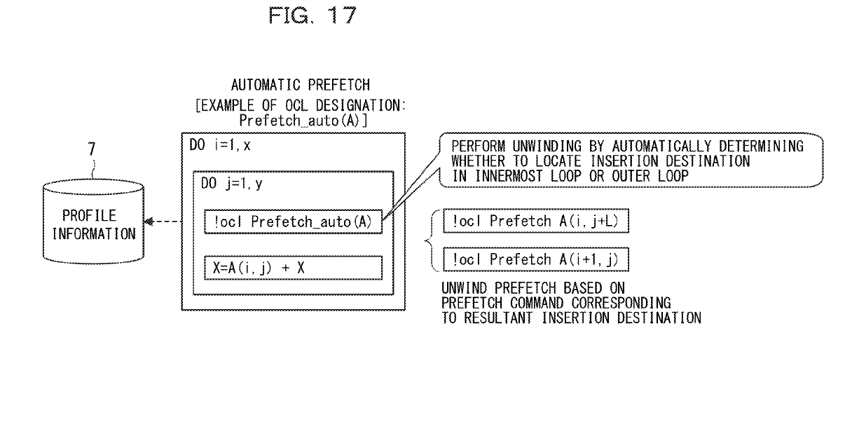

FIG. 17 illustrates the operation of the prefetch command placement unit 12 according to the second embodiment.

As illustrated in FIG. 17, when the user writes, for example, a statement “!ocl Prefetch_auto(A)” in the program, the prefetch command placement unit 12 automatically selects the innermost access scheme or the high-order access scheme on the basis of the profile information 7.

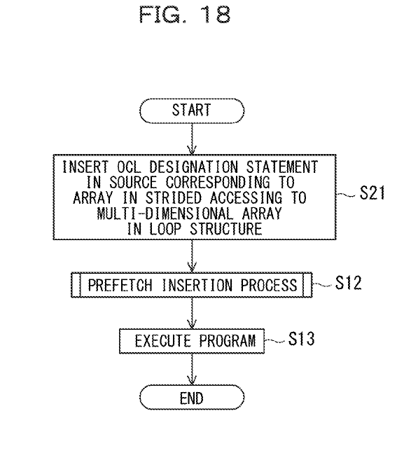

FIG. 18 is a flow chart illustrating a prefetch command process by the compiler 5 according to the second embodiment.

In the case of strided accessing to a multi-dimensional array in a multiloop structure in Step S21, the user places, for example, a statement “!ocl Prefetch_auto(A)” in the source corresponding to the array.

In Step S12, the prefetch command placement unit 12 next performs the prefetch command process illustrated in FIG. 10. In the above-described prefetch command process in FIG. 10, when the number y of execution times in the innermost loop is smaller than the number x of execution times in the outer loop, the placement unit 123 places a prefetch command at the position designated by the ocl into the outer loop through the high-order access scheme. On the other hand, when y is equal to or more than x, the placement unit 123 places a prefetch command at the position designated by the ocl into the innermost loop through the innermost access scheme.

In Step S13, the user next executes the program.

In addition to the advantageous effect achieved in the first embodiment, the user can flexibly determine the use of the innermost access scheme or the high-order access scheme at any intended position in the loop, according to the second embodiment.

This enables more effective prefetch in the program.

### (C) MODIFICATION TO SECOND EMBODIMENT

In the first and second embodiments, the prefetch command placement unit 12 automatically selects the innermost access scheme or the high-order access scheme on the basis of the profile information 7.

According to a modification to the second embodiment, a user may designate an OCL and may clearly designate the use of the innermost access scheme or the high-order access scheme.

In this case, the user investigates the number of execution times of a loop execution by use of the debugger 2 or a print statement and explicitly places an OCL statement of an optimal prefetch (the innermost access scheme or the high-order access scheme) in the source, for example.

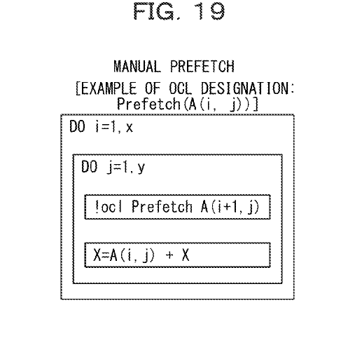

FIG. 19 illustrates the operation of the prefetch command placement unit 12 according to the modification to the second embodiment.

When the user writes, for example, a statement “!ocl Prefetch_A(i+1, j)” in the program, as illustrated in FIG. 19, the compiler 5 selects the high-order access scheme.

In this case, the position on which the scheme is selected can be described in the source more specifically than the second embodiment.

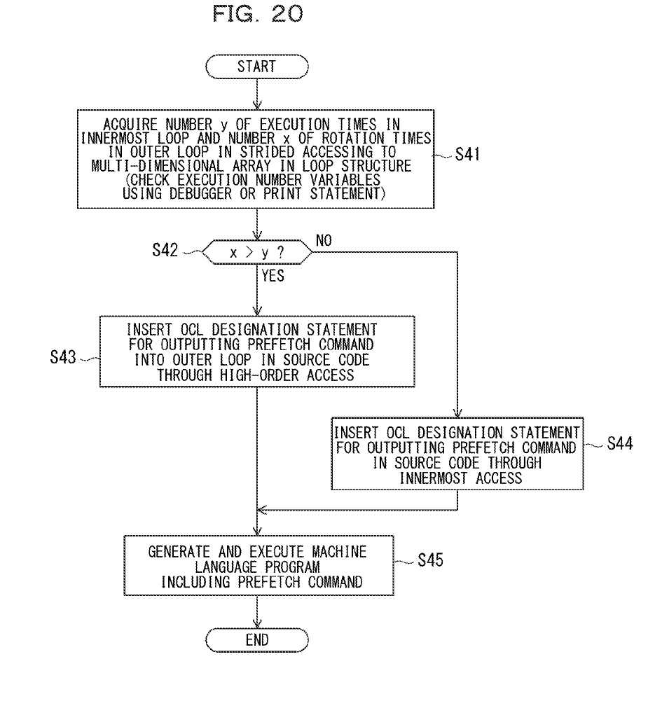

FIG. 20 is a flow chart illustrating a prefetch command process by the compiler 5 according to the modification to the second embodiment.

In the case of strided accessing to a multi-dimensional array in a multiloop structure in Step S41, the user acquires the number y of execution times of the innermost loop and the number x of execution times of the outer loop. At this time, the execution number variables x and y are checked by use of, for example, the debugger 2 or a print statement.

In Step S42, the user next determines whether the number y of execution times of the innermost loop obtained in Step S41 is smaller than the number x of execution times of the outer loop.

When y is smaller than x in Step S42 (refer to YES in Step S42), the user places an OCL designation statement into the outer loop in the source code in Step S43.

On the other hand, when y is equal to or more than x in Step S42 (refer to NO in Step S42), the user places an OCL designation statement into the innermost loop in the source code in Step S44.

In Step S45, the compiler 5 next creates a machine language program including the prefetch command.

In addition to the advantageous effect of the first embodiment, the user can flexibly determine the use of the innermost access scheme or the high-order access scheme at any intended position in the loop, according to the modification to the second embodiment enables.

This enables more effective prefetch in the program.

### (D) OTHER EXAMPLES

In the present embodiment, the high-order access scheme is employed when the number x of execution times in the outer loop is smaller than the number y of execution times in the innermost loop. The present invention is however not limited to this technique.

Alternatively, even when the number x of execution times in the outer loop is larger than the number y of execution times in the innermost loop, the compiler 5 can determine the trade-off between the latency and the number of exception access commands on the basis of the profile information 7 and can automatically select an optimal prefetch output (the innermost access scheme or the high-order access scheme).

In the present embodiment, the high-order access scheme is employed when the number x of execution times in the outer loop is smaller than the number y of execution times in the innermost loop. This case also allows the prefetch data to stay in the cache for a long period of time to cause a side effect. Even in such a circumstance, an optimal prefetch output (the innermost access scheme or the high-order access scheme) can be selected by an appropriate trade-off among the cache stay period, the latency, and the number of exception access commands.

Although a calculation process in the loop, the data dependency, and so on are disregarded in the above-described example, a selection of an optimal unwinding (the innermost access scheme or the high-order access scheme) in the present embodiment also can be achieved in view of the cycle number of the calculation process in the loop determined by, for example, the compiler 5 or the simulator. Such a selection also may be achieved on the basis of a combination of the event of a performance counter, such as a cache event, and static syntax information during translation.

The present embodiment is also applicable to a three- or more-dimensional array as well as a two-dimensional array.

For example, a three-dimensional array A(i, j, k) can be represented by A(a (i, j), k) composed of k elements including arrays a(i, j). In other words, a multi-dimensional array can be replaced with a combination of 2-dimensional arrays. Therefore, when the three-dimensional array A (i, j, k) having an array size (x, y, z) and an element size of one is accessed in the order of the directions of i, j, and k, the relative position corresponding to additional characters i, j, and k from the head region is generally represented by the following expression:

{(i−1)+(j−1)×x+(k−1)×(x×y)}×I

In this case, assuming that two prefetch targets in the access directions of j and k, respectively, in the loop are set as A(i, j+L, k) and A(i, j, k+L), the respective memory relative addresses from the array head are represented by the following expressions:

{(i−1)+(j+L−1)×x+(k−1)×(x×y)}×I, and{(i−1)+(j−1)×x+(k+L−1)×(x×y)}×I

Prefetch is performed in sequence with a stride width of L×x in the j direction and a stride width of L×x×y in the k direction.

In a similar manner, a four-dimensional array can be considered to be the same as a “two-dimensional array accessed with a stride width” in the loop access direction.

In the above embodiments, a prefetch command is unwound by software. This technique is merely an example and does not limit the present invention. For example, the present embodiment is also applicable even to an equivalent hardware prefetch mechanism executing a prefetch function in the cache memory 25 as well as a software prefetch command based on the profile information 7.

The embodiments disclosed herein can also be achieved by a combination of hardware, firmware, and/or software. Any description name, description format, and translation option name of the ocl can be selected as appropriate. Proper modifications can be applied without departing from the scope and spirit of the present embodiment.

In the present embodiment, the high-order access scheme is employed when the number x of execution times in the outer loop is smaller than the number y of execution times in the innermost loop. The present invention is however not limited to this technique.

Although a calculation process in the loop, the data dependency, and so on are disregarded in the present embodiment, a selection of an optimal unwinding destination (the innermost access scheme or the high-order access scheme) for a prefetch command in the present embodiment also can be achieved in view of the cycle number of the calculation process in the loop determined by, for example, the compiler 5 or the simulator. Such a selection also may be achieved on the basis of the event of a performance counter, such as a cache event, and static syntax information during translation.

In the above explanation, prefetch is applied in “the case of strided accessing to a multi-dimensional array in a multiloop structure”. The present invention is however not limited to strided access at intervals but may also be applicable to access to a sequential region.

The program for performing functions as the compiler 5, the prefetch command placement unit 12, the profile acquisition unit 121, the determination unit 122, and the placement unit 123 (conversion program) are recorded on, for example, a non-transient computer-readable recording medium such as a flexible disk, a CD (for example, CD-ROM, CD-R, and CD-RW) and a DVD (for example, DVD-ROM, DVD-RAM, DVD-R, DVD+R, DVD-RW, DVD+RW, and HD DVD), a blue-ray disc, a magnetic disk, an optical disc, and a magnet-optical disk. The program read by a computer from the recording medium is transmitted to an internal or external storage to be stored therein. Alternatively, the program may be recorded on, for example, a storage (recording medium), such as a magnetic disk, an optical disc, and a magnet-optical disc to be transmitted to a computer through a communication path.

The functions of the compiler 5, the prefetch command placement unit 12, the profile acquisition unit 121, the determination unit 122, and the placement unit 123 are achieved during the execution of the program stored in an internal storage (the storage 24 of the information processing apparatus 20 in the present embodiment) by a microprocessor (the CPU 21 of the information processing apparatus 20 in the present embodiment) of a computer. At this time, the computer may read and execute the program recorded on the recording medium.

In the present embodiment, a computer is construed to include hardware and an operating system, i.e., hardware operable under control of an operating system. In a circumstance where an operating system is unnecessary and hardware is operated by only an application program, the hardware serves as a computer. The hardware includes at least a microprocessor, such as a CPU, and means for reading a computer program recorded on a recording medium. In the present embodiment, the information processing apparatus 20 functions as a computer.

The technique disclosed herein can enhance the speed of a loop process by use of a prefetch command.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A conversion apparatus for converting a source code into a machine language code, the conversion apparatus comprising:
an information obtainment unit that obtains profile information from the source code;
a determination unit that determines an optimal position of a prefetch command for access to a multi-dimensional array of multiple loops having a nest level of two or greater, on the basis of the profile information; and
a placement unit that places the prefetch command at the optimal position.

2. The conversion apparatus according to claim 1, wherein the determination unit further determines the optimal position from the number of repetition times in the innermost loop of the multiple loops and the number of repetition times in the second innermost loop.

3. The conversion apparatus according to claim 2, wherein the determination unit further determines the optimal position located in the second innermost loop if the number of repetition times in the innermost loop is smaller than the number of repetition times in the second innermost loop.

4. The conversion apparatus according to claim 1, wherein the determination unit further determines the optimal position on the basis of the number of repetition times in the innermost loop of the multiple loops, the number of repetition times in the second innermost loop, latency, and the number of exception access commands.

5. The conversion apparatus according to claim 4, wherein the determination unit further determines trade-off between the latency and the number of the exception access commands on the basis of the profile information and to determine the optimal position if the number of execution times in the innermost loop is larger than the number of execution times in an outer loop.

6. A method of converting a source code into a machine language code, the method comprising:
obtaining profile information from the source code;
determining an optimal position of a prefetch command for access to a multi-dimensional array of multiple loops having a nest level of two or greater, on the basis of the profile information; and
placing the prefetch command at the optimal position.

7. The method according to claim 6, wherein the determining further determines the optimal position from the number of repetition times in the innermost loop of the multiple loops and the number of repetition times in the second innermost loop.

8. The method according to claim 7, wherein the determining further determines the optimal position to be located in the second innermost loop if the number of repetition times in the innermost loop is smaller than the number of repetition times in the second innermost loop.

9. The method according to claim 6, wherein the determining further determines the optimal position on the basis of the number of repetition times in the innermost loop of the multiple loops, the number of repetition times in the second innermost loop, latency, and the number of exception access commands.

10. The method according to claim 9, wherein the determining further determines trade-off between the latency and the number of the exception access commands on the basis of the profile information and to determine the optimal position if the number of execution times in the innermost loop is larger than the number of execution times in an outer loop.

11. A non-transient computer-readable recording medium that records a non-transient computer-readable recording medium having a conversion program stored thereon, for converting a source code into a machine language code, the conversion program being executed by a computer and causing the computer to:
obtain profile information from the source code;
determine an optimal position of a prefetch command for access to a multi-dimensional array of multiple loops having a nest level of two or greater, on the basis of the profile information; and
place the prefetch command at the optimal position.

12. The non-transient computer-readable recording medium according to claim 11, wherein the conversion program executed by the computer causes the computer to further determine the optimal position on the basis of the number of repetition times in the innermost loop of the multiple loops and the number of repetition times in the second innermost loop.

13. The non-transient computer-readable recording medium according to claim 12, wherein the conversion program executed by the computer causes the computer to further determine the optimal position located in the second innermost loop if the number of repetition times in the innermost loop is smaller than the number of repetition times in the second innermost loop.

14. The non-transient computer-readable recording medium according to claim 11, wherein the conversion program executed by the computer causes the computer to further determine the optimal position on the basis of the number of repetition times in the innermost loop of the multiple loops, the number of repetition times in the second innermost loop, latency, and the number of exception access commands.

15. The non-transient computer-readable recording medium according to claim 14, wherein the conversion program executed by the computer causes the computer to further determine trade-off between the latency and the number of the exception access commands on the basis of the profile information and to determine the optimal position if the number of execution times in the innermost loop is larger than the number of execution times in an outer loop.
